(19) United States
(12) Patent Application Publication
(10) Pub. No.: US 2020/0209424 A1
(43) Pub. Date: Jul. 2, 2020

(54) METHOD AND DEVICE FOR IDENTIFYING MICROFACIES OF LIMESTONE SHOAL

(71) Applicant: Yangtze University, Jingzhou (CN)

(72) Inventors: Mingyi Hu, Jingzhou (CN); Da Gao, Jingzhou (CN)

(21) Appl. No.: 16/732,080

(22) Filed: Dec. 31, 2019

(30) Foreign Application Priority Data
Jan. 2, 2019 (CN) 201910001864.8

(51) Int. Cl. G01V 3/18; G01V 3/38

(52) U.S. Cl. CPC G01V 3/18; G01V 2200/10; G01V 3/38

(57) ABSTRACT

Embodiments of the present invention provide a method and device for identifying microfacies of a limestone shoal. The method includes: establishing identification charts of different microfacies of a limestone shoal according to core and thin section data, constructing natural gamma-ray (GR) response templates of different microfacies of a limestone shoal of a standard drilled well, and standardizing a GR curve of a non-standard drilled well according to a GR curve of the limestone shoal of the standard drilled well; comparing the standardized GR curve of the non-standard drilled well with the GR response template of the standard drilled well to divide microfacies of a limestone shoal of the non-standard drilled well.

### TECHNICAL FIELD

Embodiments of the present invention relate to the technical field of geological science, and in particular to a method and device for identifying microfacies of a limestone shoal.

### BACKGROUND

A carbonate shoal refers to a thick layer deposit mainly composed of grain limestone or grain dolomite by deposition. A carbonate shoal is one of the important types of carbonate oil and gas reservoirs. Many large oil and gas fields have been discovered in the world, such as Lakin oil field in the United States and Kish oil field in Iran. Fine division of microfacies types of shoals is of great significance for finding out the spatial and temporal distribution of shoals and predicting favorable shoal facies oil and gas reservoirs.

Although a great deal of shoal microfacies division work has been carried out on the basis of core, thin section and logging data, the microfacies division solutions are not consistent, and standards for different microfacies are still unclear. At present, the following two shoal microfacies division solutions are commonly used: (1) according to a particle composition, the shoals can be divided into a calcirudite shoal, a calcarenite shoal and a calcilutite shoal; (2) the shoals can be divided into a high-energy shoal, a medium-energy shoal and a low-energy shoal according to the difference of sedimentary hydrodynamic conditions reflected by lithologic combination patterns of the shoal; and (3) according to different positions of shoal bodies, a shallow sea environment in which the shoal is developed can be divided into a shoal body (a shoal core), a shoal edge (a shoal wing) and an intershoal sea. The division solution according to the particle composition usually needs to be based on the fine analysis of a core and a thin section of a drilled well. The division solution according to hydrodynamic differences usually requires comprehensive analysis of core and logging data. The division solution according to shoal development environment usually requires a combination of a single well, a connected well and a plane based on a large number of drilling analysis.

Therefore, under the condition of very limited coring data, in order to achieve the microfacies division of the shoal mainly based on logging data, an optimal microfacies solution is selected: shoal microfacies are divided according to lithologic combination and sedimentary hydrodynamic force reflected by the lithologic combination, and different microfacies types of the shoal are identified based on core and logging data. That is, what are the characteristics and differences of shoal microfacies of different sedimentary hydrodynamic conditions on logging responses become the primary technical problem to be solved in carrying out single well shoal microfacies analysis, dividing different shoal development environments and carrying out reservoir analysis.

### SUMMARY

In view of the foregoing problems existing in the prior art, embodiments of the present invention provide a method and device for identifying microfacies of a limestone shoal.

In a first aspect, an embodiment of the present invention provides a method for identifying microfacies of a limestone shoal, including: establishing identification charts of different microfacies of a limestone shoal according to core and thin section data, constructing natural gamma-ray (GR) response templates of different microfacies of a limestone shoal of a standard drilled well, and standardizing a GR curve of a non-standard drilled well according to a GR curve of the limestone shoal of the standard drilled well; comparing the standardized GR curve of the non-standard drilled well with the GR response template of the standard drilled well to divide microfacies of a limestone shoal of the non-standard drilled well.

Further, types of identification charts of different microfacies of the limestone shoal include a thin section identification chart of a high-energy limestone shoal, a thin section identification chart of a medium-energy limestone shoal and a thin section identification chart of a low-energy limestone shoal.

Further, with respect to a composition of the thin section identification chart of the high-energy limestone shoal, the content of particles in thin sections is greater than 70%, a particle diameter is 0.2 mm to 1.5 mm, the roundness is subcircular to circular, sparry calcite is between the particles, and there is no micrite matrix; and the core includes massive bedding, parallel bedding and/or cross bedding.

Further, with respect to a composition of the thin section identification chart of the medium-energy limestone shoal, the content of particles in thin sections is greater than 60%, a particle diameter is 0.1 mm to 1 mm, the roundness is subangular, and there is a micrite matrix between the particles; and a core includes a horizontally-laminated bed; and a core includes a horizontally-laminated bed.

Further, with respect to a composition of the thin section identification chart of the low-energy limestone shoal, a thin section is mainly composed of a micrite matrix, the content of particles is less than 30%, and a particle diameter is 0.02 mm to 0.1 mm; and a core includes a horizontally-laminated bed.

Further, the constructing GR response templates of different microfacies of a limestone shoal of a standard drilled well includes: analyzing thin section identification charts of the limestone shoal and the GR curve of the standard drilled well to determine GR response templates of different microfacies.

Further, the standardizing a GR curve of a non-standard drilled well according to a GR curve of the limestone shoal of the standard drilled well includes:

GRₛₐ=S₁+(GRₐ−W₁ₐ)/Rₐ

Rₐ=(W₁ₐ−W_{2b})/(S₂−S₁)

where GRₛₐ is a standardized non-standard drilled well GR, GRₐ is a non-standard drilled well GR before standardization, S₁ is an average GR of high-energy limestone shoal microfacies of a standard drilled well, S₂ is an average GR of intershoal sea microfacies of the standard drilled well, W₁ₐ is an average GR of high-energy limestone shoal microfacies of a non-standard drilled well, Rₐ is a standardized parameter of the non-standard drilled well, and W_{2b} is an average GR of intershoal sea microfacies of the non-standard drilled well.

In a second aspect, the embodiment of the present invention provides a device for identifying microfacies of a limestone shoal, including:

a logging response curve acquisition module, configured to establish identification charts of different microfacies of a limestone shoal according to core and thin section data, construct GR response templates of different microfacies of a limestone shoal of a standard drilled well, and standardize a GR curve of a non-standard drilled well according to a GR curve of the limestone shoal of the standard drilled well; and

a limestone shoal microfacies acquisition module, configured to compare the standardized GR curve of the non-standard drilled well with the GR response template of the standard drilled well to divide microfacies of a limestone shoal of the non-standard drilled well.

In a third aspect, an embodiment of the present invention provides an electronic device, including:

at least one processor; and

at least one memory in communication connection with the processor, where

the memory stores program instructions executable by the processor, and the processor calls the program instructions to execute the method for identifying microfacies of a limestone shoal provided by any one of the various possible implementations of the first aspect.

In a fourth aspect, an embodiment of the present invention provides a non-transitory computer readable storage medium that stores computer instructions, and the computer instructions cause a computer to execute the method for identifying microfacies of a limestone shoal provided by any one of the various possible implementations of the first aspect.

According to the method and device for identifying microfacies of a limestone shoal provided by the embodiments of the present invention, based on the analysis of core and thin section identification charts of the limestone shoal, the GR response template of the standard drilled well is established. Then, the GR curve of the non-standard drilled well is compared with the GR response template of the standard drilled well, so that microfacies of limestone shoals of a plurality of drilled wells can be effectively identified.

### BRIEF DESCRIPTION OF THE DRAWINGS

To describe the technical solutions in the embodiments of the present invention or in the prior art more clearly, the following briefly introduces the accompanying drawings required for describing the embodiments or the prior art. Apparently, the accompanying drawings in the following description show some embodiments of the present invention, and a person of ordinary skill in the art may still derive other drawings from these accompanying drawings without creative efforts.

FIG. 1 is a flowchart of a method for identifying microfacies of a limestone shoal provided by an embodiment of the present invention;

FIG. 2 is a schematic diagram of core and thin section identification charts of various limestone shoals provided by an embodiment of the present invention;

FIG. 3 is a schematic diagram of a GR response template of a limestone shoal of a standard drilled well provided by an embodiment of the present invention;

FIG. 4 is a schematic diagram of a standardized GR curve of a non-standard drilled well and a compared microphase identification solution provided by an embodiment of the present invention;

FIG. 5 is a schematic structural diagram of a device for identifying microfacies of a limestone shoal provided by an embodiment of the present invention; and

FIG. 6 is a schematic physical structure diagram of an electronic device provided by an embodiment of the present invention.

### DETAILED DESCRIPTION

In order to make the objectives, technical solutions and advantages of the embodiments of the present invention clearer, the following clearly and completely describes the technical solutions in the embodiments of the present invention with reference to accompanying drawings in the embodiments of the present invention. Apparently, the described embodiments are some rather than all of the embodiments. All other embodiments obtained by a person of ordinary skill in the art based on the embodiments of the present invention without creative efforts shall fall within the protection scope of the present invention. In addition, technical features of each embodiment or a single embodiment provided by the present invention can be combined arbitrarily with each other to form a feasible technical solution, but it must be based on the realization by those of ordinary skill in the art. When the combination of technical solution is contradictory or cannot be realized, it should be considered that the combination of such technical solutions does not exist and is not within the protection scope claimed by the present invention.

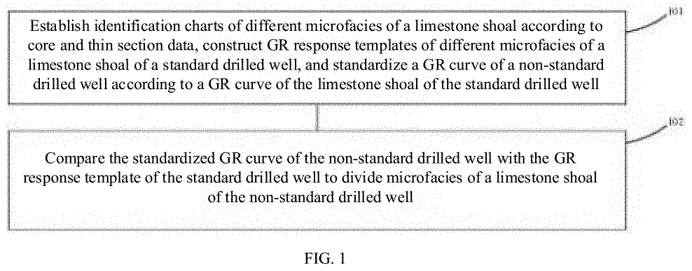

An embodiment of the present invention provides a method for identifying microfacies of a limestone shoal. Referring to FIG. 1, the method includes the following steps.

Step 101: Establish identification charts of different microfacies of a limestone shoal according to core and thin section data, construct GR response templates of different microfacies of a limestone shoal of a standard drilled well, and standardize a GR curve of a non-standard drilled well according to a GR curve of the limestone shoal of the standard drilled well.

Step 102: Compare the standardized GR curve of the non-standard drilled well with the GR response template of the standard drilled well to divide microfacies of a limestone shoal of the non-standard drilled well.

On the basis of the foregoing embodiment, in the method for identifying microfacies of a limestone shoal provided by an embodiment of the present invention, types of identification charts of different microfacies of the limestone shoal include a thin section identification chart of a high-energy limestone shoal, a thin section identification chart of a medium-energy limestone shoal and a thin section identification chart of a low-energy limestone shoal.

On the basis of the foregoing embodiment, in the method for identifying microfacies of a limestone shoal provided by an embodiment of the present invention, with respect to a composition of the thin section identification chart of the high-energy limestone shoal, the content of particles in thin sections is greater than 70%, a particle diameter is 0.2 mm to 1.5 mm, the roundness is subcircular to circular, sparry calcite is between the particles, and there is no micrite matrix; and the core includes massive bedding, parallel bedding and/or cross bedding.

On the basis of the foregoing embodiment, in the method for identifying microfacies of a limestone shoal provided by an embodiment of the present invention, with respect to a composition of the thin section identification chart of the medium-energy limestone shoal, the content of particles in thin sections is greater than 60%, a particle diameter is 0.1 mm to 1 mm, the roundness is subangular, and there is a micrite matrix between the particles; and a core includes a horizontally-laminated bed; and a core includes a horizontally-laminated bed. The particle types are mainly pelletoid, sand crumbs and crude crumbs. Sparry calcite cements may be developed locally between particles.

On the basis of the foregoing embodiment, in the method for identifying microfacies of a limestone shoal provided by an embodiment of the present invention, with respect to a composition of the thin section identification chart of the low-energy limestone shoal, a thin section is mainly composed of a micrite matrix, the content of particles is less than 30%, and a particle diameter is 0.02 mm to 0.1 mm; and a core includes a horizontally-laminated bed.

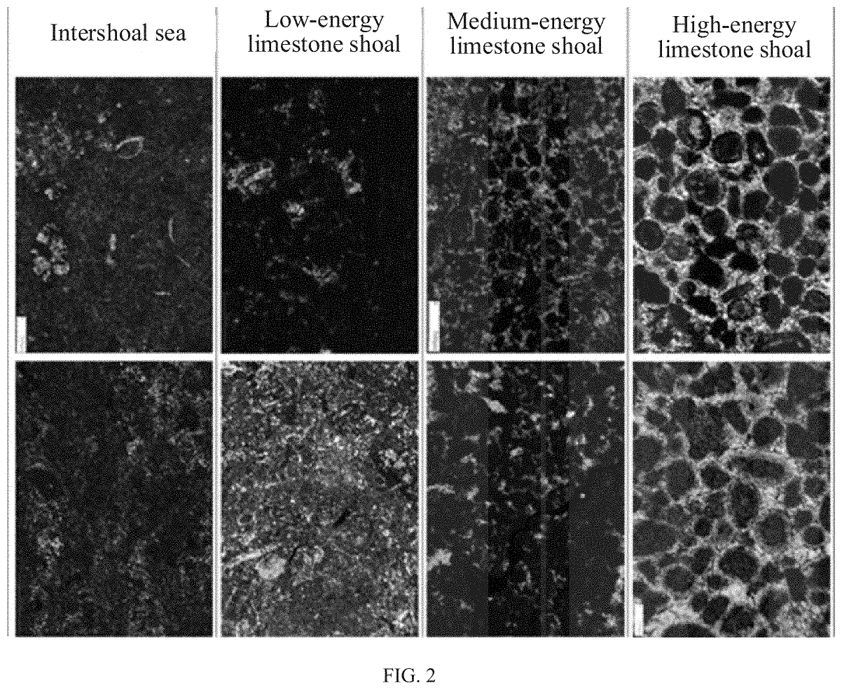

In addition, the types of the core and thin section identification charts of the limestone shoal further include an intershoal sea. The intershoal sea includes micrite doped with a small amount of wackestone. A reference is made to FIG. 2 for core and thin section identification charts of limestone shoals of the foregoing embodiments. In FIG. 2, a high-energy limestone shoal, a medium-energy limestone shoal and a low-energy limestone shoal are included. In FIG. 2, there are thin section identification charts.

On the basis of the foregoing embodiment, in the method for identifying microfacies of a limestone shoal provided by an embodiment of the present invention, the constructing GR response templates of different microfacies of a limestone shoal of a standard drilled well includes: analyzing thin section identification charts of the limestone shoal and the GR curve of the standard drilled well to determine GR response templates of different microfacies. Specifically, the GR value and curve shape can reflect the hydrodynamic force during the deposition of a shoal. The stronger the hydrodynamic force, the faster the deposition rate. Small clay cannot be deposited, radioactive substances adsorbed are less, and the content of radioactive clay minerals is extremely low, so the GR value is lower. In contrast, when the deposition rate is slow, sediments adsorb more radioactive substances from the water body, and the content of radioactive clay minerals increases, so the GR value is higher. In GR curve shape, a high-energy shoal usually shows a low value and a smooth box shape, a medium-energy shoal shows a medium-low value and a medium jugged funnel-box shape, and a low-energy shoal shows medium-high value and medium-strong jugged shape.

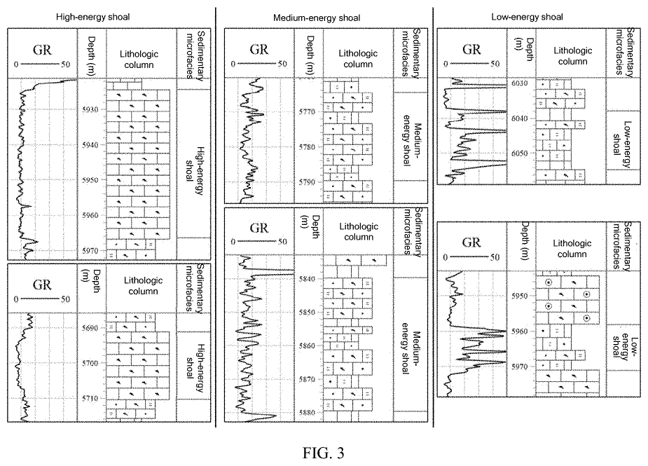

Specifically, a reference may be made to FIG. 3. In FIG. 3, a high-energy shoal (namely a high-energy limestone shoal), a medium-energy shoal (namely medium-energy limestone shoal) and a low-energy shoal (namely a low-energy limestone shoal) are included. The GR curves of different microfacies of each shoal each include a GR, a depth, a lithologic column and sedimentary microfacies and other parameters. The specific GR curve is described above and will not be repeated again.

On the basis of the foregoing embodiment, in the method for identifying microfacies of a limestone shoal provided by an embodiment of the present invention, the standardizing a GR curve of a non-standard drilled well according to a GR curve of the limestone shoal of the standard drilled well includes:

GRₛₐ=S₁+(GRₐ−W₁ₐ)/Rₐ

Rₐ=(W₁ₐ−W_{2b})/(S₂−S₁)

where GRₛₐ is a standardized non-standard drilled well GR, GRₐ is a non-standard drilled well GR before standardization, S₁ is an average GR of high-energy limestone shoal microfacies of a standard drilled well, S₂ is an average GR of intershoal sea microfacies of the standard drilled well, W₁ₐ is an average GR of high-energy limestone shoal microfacies of a non-standard drilled well, Rₐ is a standardized parameter of the non-standard drilled well, and W_{2b} is an average GR of intershoal sea microfacies of the non-standard drilled well. It should be noted that there may be a plurality of foregoing non-standard drilled wells in practice, and all non-standard drilled wells need to be standardized.

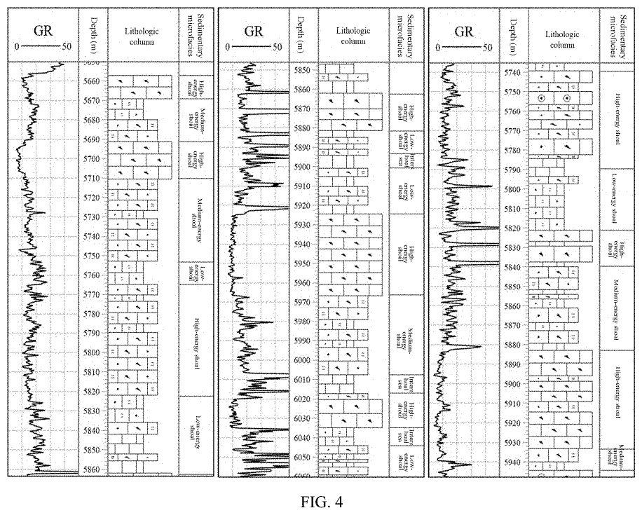

A reference may be made to FIG. 4 for constructed limestone shoal microfacies. In FIG. 4, a high-energy shoal (namely a high-energy limestone shoal), a medium-energy shoal (namely medium-energy limestone shoal), a low-energy shoal (namely a low-energy limestone shoal), and parameters such as a GR curve, a depth, a lithologic column and sedimentary microfacies are included. As can be seen from FIG. 4, for drilled wells at different depths (between 5660 m and 6060 m), the microfacies of the limestone shoals are fine, clear and distinguishable. In the fine study of Ordovician carbonate shoals in Tarim basin and Cambrian carbonate shoals in Sichuan basin, the microfacies types of shoals have been finely divided and good results have been achieved. This will lay a good foundation for clear spatial distribution of microfacies and reservoir prediction.

According to the method for identifying microfacies of a limestone shoal provided by the embodiments of the present invention, based on the analysis of core and thin section identification charts of the limestone shoal, the GR response template of the standard drilled well is established, and the GR curve of the non-standard drilled well is compared with the GR response template of the standard drilled well, so that microfacies of limestone shoals of a plurality of drilled wells can be effectively identified.

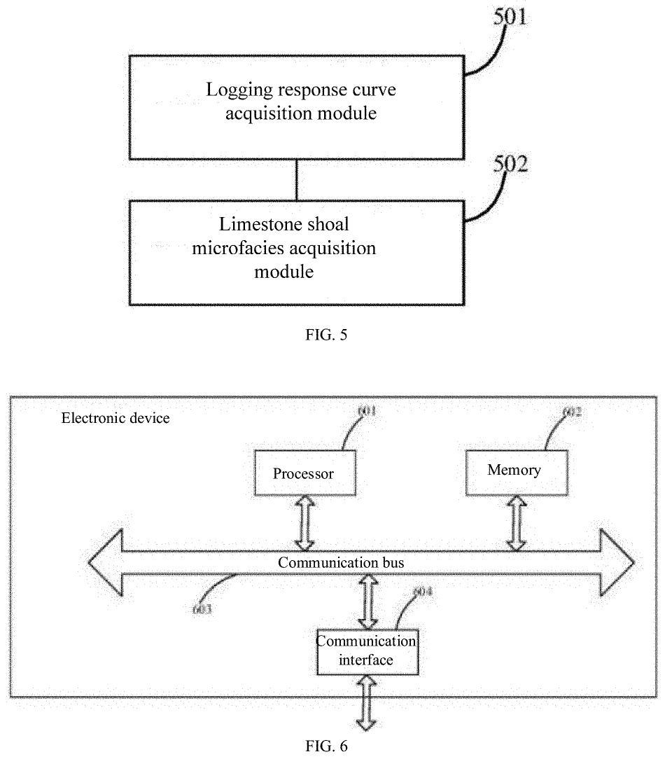

The implementation basis of various embodiment of the present invention is achieved through programmed processing by a device having processor functions. Therefore, in engineering practice, the technical solutions and functions of various embodiments of the present invention can be packaged into various modules. Based on this reality, on the basis of the foregoing embodiments, the embodiment of the present invention provides a device for identifying microfacies of a limestone shoal, and the device is used for executing the method for identifying microfacies of a limestone shoal in the foregoing method embodiment. Referring to FIG. 5, the device includes:

a logging response curve acquisition module 501, configured to establish identification charts of different microfacies of a limestone shoal according to core and thin section data, construct GR response templates of different microfacies of a limestone shoal of a standard drilled well, and standardize a GR curve of a non-standard drilled well according to a GR curve of the limestone shoal of the standard drilled well; and a limestone shoal microfacies acquisition module 502, configured to compare the standardized GR curve of the non-standard drilled well with the GR response template of the standard drilled well to divide microfacies of a limestone shoal of the non-standard drilled well.

According to the device for identifying microfacies of a limestone shoal provided by the embodiments of the present invention, by adopting the logging response curve acquisition module and the limestone shoal microfacies acquisition module, the GR response templates of different microfacies of the limestone shoal of the standard drilled well are established through the analysis of core and thin section identification charts of the limestone shoal, and the standardized GR curve of the non-standard drilled well is compared with the GR response template of the standard drilled well, so that microfacies of limestone shoals of a plurality of drilled wells can be effectively identified.

The method of the embodiment of the present invention is realized by relying on an electronic device, so it is necessary to introduce the relevant electronic device. Based on the objective, an embodiment of the present invention provides an electronic device, as shown in FIG. 6, which includes at least one processor 601, a communication interface 604, at least one memory 602 and a communication bus 603, where the at least one processor 601, the communication interface 604 and the at least one memory 602 complete communication with each other through the communication bus 603. The at least one processor 601 may call logic instructions in the at least one memory 602 to perform the following method including: establishing identification charts of different microfacies of a limestone shoal according to core and thin section data, constructing GR response templates of different microfacies of a limestone shoal of a standard drilled well, and standardizing a GR curve of a non-standard drilled well according to a GR curve of the limestone shoal of the standard drilled well; comparing the standardized GR curve of the non-standard drilled well with the GR response template of the standard drilled well to divide microfacies of a limestone shoal of the non-standard drilled well.

In addition, the logic instructions in the foregoing at least one memory 602 can be implemented in the form of software function units and can be stored in a computer readable storage medium when sold or used as independent products. Based on such understanding, the technical solution of the present invention which is essential or a part contributing to the prior art or a part of the technical solution may be embodied in the form of a software product, the computer software product is stored in a storage medium and includes a plurality of instructions for causing a computer device (which may be a personal computer, a server, or a network device) to execute all or some steps of the method according to each embodiment of the present invention. For example, the method includes the following steps: establishing identification charts of different microfacies of a limestone shoal according to core and thin section data, constructing GR response templates of different microfacies of a limestone shoal of a standard drilled well, and standardizing a GR curve of a non-standard drilled well according to a GR curve of the limestone shoal of the standard drilled well; comparing the standardized GR curve of the non-standard drilled well with the GR response template of the standard drilled well to divide microfacies of a limestone shoal of the non-standard drilled well. The foregoing storage medium includes: a USB flash disk, a mobile hard disk, a read-only memory (ROM), a random access memory (RAM), a magnetic disk, or an optical disk, and the like, which can store program codes.

The device embodiments described above are only schematic, where units described as separate components may or may not be physically separated. Components displayed as units may or may not be physical units, that is, the components may be located in one place, or may be distributed to multiple network units. Some or all of the modules may be selected according to actual needs to achieve the objective of the solution of the embodiment. Those of ordinary skill in the art can understand and implement the embodiment without creative labor.

Through the description of the foregoing embodiments, those skilled in the art can clearly understand that the embodiments can be implemented by means of software plus a necessary universal hardware platform, or certainly, can be implemented through hardware. Based on such understanding, the foregoing technical solution which is essential or a part contributing to the prior art may be embodied in the form of a software product, the computer software product may be stored in a computer readable storage medium, such as an ROM/RAM, a magnetic disk or an optical disk, including a plurality of instructions for causing a computer device (which may be a personal computer, a server, or a network device) to perform the methods described in the embodiments or some parts of the embodiments.

Finally, it should be noted that the foregoing embodiments are only used to explain the technical solutions of the present invention, and are not intended to limit the same. Although the present invention is described in detail with reference to the foregoing embodiments, those of ordinary skill in the art should understand that they can still modify the technical solutions described in the foregoing embodiments, or make equivalent substitutions on some technical features therein. These modifications or substitutions do not make the essence of the corresponding technical solutions deviate from the spirit and scope of the technical solutions of the embodiments of the present invention.

What is claimed is:

1. A method for identifying microfacies of a limestone shoal, comprising:
establishing identification charts of different microfacies of a limestone shoal according to core and thin section data, constructing natural gamma-ray (GR) response templates of different microfacies of a limestone shoal of a standard drilled well, and standardizing a GR curve of a non-standard drilled well according to a GR curve of the limestone shoal of the standard drilled well; and
comparing the standardized GR curve of the non-standard drilled well with the GR response template of the standard drilled well to divide microfacies of a limestone shoal of the non-standard drilled well.

2. The method for identifying microfacies of a limestone shoal according to claim 1, wherein types of identification charts of different microfacies of the limestone shoal comprise:
a thin section identification chart of a high-energy limestone shoal, a thin section identification chart of a medium-energy limestone shoal and a thin section identification chart of a low-energy limestone shoal.

3. The method for identifying microfacies of a limestone shoal according to claim 2, wherein with respect to a composition of the thin section identification chart of the high-energy limestone shoal,
the content of particles in thin sections is greater than 70%, a particle diameter is 0.2 mm to 1.5 mm, the roundness is subcircular to circular, sparry calcite is between the particles, and there is no micrite matrix; and
a core comprises massive bedding, parallel bedding and/or cross bedding.

4. The method for identifying microfacies of a limestone shoal according to claim 2, wherein with respect to a composition of the thin section identification chart of the medium-energy limestone shoal,
the content of particles in thin sections is greater than 60%, a particle diameter is 0.1 mm to 1 mm, the roundness is subangular, and there is a micrite matrix between the particles; and
a core comprises a horizontally-laminated bed.

5. The method for identifying microfacies of a limestone shoal according to claim 2, wherein with respect to a composition of the thin section identification chart of the low-energy limestone shoal,
a thin section is mainly composed of a micrite matrix, the content of particles is less than 30%, and a particle diameter is 0.02 mm to 0.1 mm; and
a core comprises a horizontally-laminated bed.

6. The method for identifying microfacies of a limestone shoal according to claim 1, wherein the constructing GR response templates of different microfacies of a limestone shoal of a standard drilled well comprises:
analyzing thin section identification charts of the limestone shoal and the GR curve of the standard drilled well to determine GR response templates of different microfacies.

7. The method for identifying microfacies of a limestone shoal according to claim 6, wherein the standardizing a GR curve of a non-standard drilled well according to a GR curve of the limestone shoal of the standard drilled well comprises:
GRₛₐ=S₁+(GRₐ−W₁ₐ)/Rₐ
Rₐ=(W₁ₐ−W_{2b})/(S₂−S₁)
wherein GRₛₐ is a standardized non-standard drilled well GR, GRₐ is a non-standard drilled well GR before standardization, S₁ is an average GR of high-energy limestone shoal microfacies of a standard drilled well, S₂ is an average GR of intershoal sea microfacies of the standard drilled well, W₁ₐ is an average GR of high-energy limestone shoal microfacies of a non-standard drilled well, Rₐ is a standardized parameter of the non-standard drilled well, and W_{2b} is an average GR of intershoal sea microfacies of the non-standard drilled well.

8. A device for identifying microfacies of a limestone shoal, comprising:
a logging response curve acquisition module, configured to establish identification charts of different microfacies of a limestone shoal according to core and thin section data, construct GR response templates of different microfacies of a limestone shoal of a standard drilled well, and standardize a GR curve of a non-standard drilled well according to a GR curve of the limestone shoal of the standard drilled well; and
a limestone shoal microfacies acquisition module, configured to compare the standardized GR curve of the non-standard drilled well with the GR response template of the standard drilled well to divide microfacies of a limestone shoal of the non-standard drilled well.

9. An electronic device, comprising:
at least one processor, at least one memory, a communication interface and a bus, wherein
the processor, the memory and the communication interface complete communication with each other through the bus; and
the memory stores program instructions executable by the processor, and the processor calls the program instructions to perform the method according to claim 1.

10. An electronic device, comprising:
at least one processor, at least one memory, a communication interface and a bus, wherein
the processor, the memory and the communication interface complete communication with each other through the bus; and
the memory stores program instructions executable by the processor, and the processor calls the program instructions to perform the method according to claim 2.

11. An electronic device, comprising:
at least one processor, at least one memory, a communication interface and a bus, wherein
the processor, the memory and the communication interface complete communication with each other through the bus; and
the memory stores program instructions executable by the processor, and the processor calls the program instructions to perform the method according to claim 3.

12. An electronic device, comprising:
at least one processor, at least one memory, a communication interface and a bus, wherein
the processor, the memory and the communication interface complete communication with each other through the bus; and
the memory stores program instructions executable by the processor, and the processor calls the program instructions to perform the method according to claim 4.

13. An electronic device, comprising:
at least one processor, at least one memory, a communication interface and a bus, wherein
the processor, the memory and the communication interface complete communication with each other through the bus; and
the memory stores program instructions executable by the processor, and the processor calls the program instructions to perform the method according to claim 5.

14. An electronic device, comprising:
at least one processor, at least one memory, a communication interface and a bus, wherein
the processor, the memory and the communication interface complete communication with each other through the bus; and
the memory stores program instructions executable by the processor, and the processor calls the program instructions to perform the method according to claim 6.

15. A non-transient computer readable storage medium, wherein the non-transient computer readable storage medium stores computer instructions, and the computer instructions cause a computer to perform the method according to claim 1.

16. A non-transient computer readable storage medium, wherein the non-transient computer readable storage medium stores computer instructions, and the computer instructions cause a computer to perform the method according to claim 2.

17. A non-transient computer readable storage medium, wherein the non-transient computer readable storage medium stores computer instructions, and the computer instructions cause a computer to perform the method according to claim 3.

18. A non-transient computer readable storage medium, wherein the non-transient computer readable storage medium stores computer instructions, and the computer instructions cause a computer to perform the method according to claim 4.

19. A non-transient computer readable storage medium, wherein the non-transient computer readable storage medium stores computer instructions, and the computer instructions cause a computer to perform the method according to claim 5.

20. A non-transient computer readable storage medium, wherein the non-transient computer readable storage medium stores computer instructions, and the computer instructions cause a computer to perform the method according to claim 6.
